(19) United States
(12) Patent Application Publication
(10) Pub. No.: US 2017/0015947 A1
(43) Pub. Date: Jan. 19, 2017

(54) Acidic hard surface cleaners comprising a solvent

(71) Applicant: The Procter & Gamble Company, Cincinnati, OH (US)

(72) Inventors: Laura CERMENATI, Brussels (BE); Aicha DKIDAK, Brussels (BE); Denis Alfred GONZALES, Brussels (BE); Marina Jozefa HERMIE, Hever (BE); James Robert TINLIN, Brussels (BE)

(21) Appl. No.: 15/206,347

(22) Filed: Jul. 11, 2016

(30) Foreign Application Priority Data
Jul. 13, 2015 (EP) 15 176 527.8

(51) Int. Cl. C11D 3/20; C11D 1/14; C11D 3/37; C11D 1/00; C11D 17/00; C11D 1/66; C11D 3/43; C11D 3/22

(52) U.S. Cl. CPC C11D 3/2079; C11D 3/2068; C11D 3/43; C11D 1/146; C11D 3/222; C11D 1/002; C11D 17/0008; C11D 1/66; C11D 3/2086; C11D 3/3776

(57) ABSTRACT

Acidic hard surface cleaning compositions comprising a glycol ether solvent and having a pH of less than about 7, can be used for providing a combination of lime scale removal and removal of hydrophobic stains.

### FIELD OF THE INVENTION

Acidic hard surface cleaning compositions comprising glycol ether solvent for improved stain removal in the presence of limescale.

### BACKGROUND OF THE INVENTION

Acidic hard surface cleaning compositions are well known for their efficacy in treating limescale deposits, and hence are commonly used for cleaning bathrooms and bathroom fittings. However, they are typically less effective at removing hydrophobic stains, such as oils, fats, and polymerised grease from surfaces. Hence, acid cleaners are less used in other areas where both limescale and hydrophobic stains are present, such as kitchens and the like. However, hard surfaces which are present in kitchens, and the like, often include surfaces which are more delicate than those found in bathrooms.

As such, a need remains for hard surface cleaner which is effective at cleaning both limescale and hydrophobic stains, and is suitable over a wide range of surfaces.

EP0957156 A1 relates to a liquid acidic cleaning compositions suitable for cleaning bathroom surfaces comprising a homo or copolymer of vinylpyrrolidone, and an acid for delivering improved shine as well as improved next-time cleaning benefit. US 2005/0233925 A1 relates to compositions comprising an organic solvent, for removing polymerised grease. US2004/0157763 A1 relates to hard surface cleaning compositions comprising an organic solvent and malodour control agent.

### SUMMARY OF THE INVENTION

The present invention relates to a liquid acidic hard surface cleaning composition comprising a glycol ether solvent.

The present invention further relates to a method of treating a hard surface, and the use of hard surface treatment compositions for removing hydrophobic stains.

### DETAILED DESCRIPTION OF THE INVENTION

Acidic hard surface cleaning compositions comprising a glycol ether solvent, as disclosed herein, are effective at cleaning both limescale and hydrophobic stains. When formulated with an acid system based on formic acid, the acidic hard surface cleaning composition is also suitable for use over a wider range of hard surfaces, including those found in kitchens, and the like.

As defined herein, “essentially free of” a component means that no amount of that component is deliberately incorporated into the respective premix, or composition. Preferably, “essentially free of” a component means that no amount of that component is present in the respective premix, or composition.

As used herein, “isotropic” means a clear mixture, having little or no visible haziness, phase separation and/or dispersed particles, and having a uniform transparent appearance.

As defined herein, “stable” means that no visible phase separation is observed for a premix kept at 25° C. for a period of at least two weeks, or at least four weeks, or greater than a month or greater than four months, as measured using the Floc Formation Test, described in USPA 2008/0263780 A1.

All percentages, ratios and proportions used herein are by weight percent of the premix, unless otherwise specified. All average values are calculated “by weight” of the premix, unless otherwise expressly indicated.

All measurements are performed at 25° C. unless otherwise specified.

Unless otherwise noted, all component or composition levels are in reference to the active portion of that component or composition, and are exclusive of impurities, for example, residual solvents or by-products, which may be present in commercially available sources of such components or compositions.

### Liquid Hard Surface Cleaning Composition:

The compositions according to the present invention are designed as hard surfaces cleaners. The compositions according to the present invention are liquid compositions (including gels) as opposed to a solid or a gas.

The liquid acidic hard surface cleaning compositions according to the present invention are preferably aqueous compositions. Therefore, they may comprise from 70% to 99% by weight of the total composition of water, preferably from 75% to 95% and more preferably from 80% to 95%.

In a preferred embodiment according to the present invention the compositions herein have a water-like viscosity. By “water-like viscosity” it is meant herein a viscosity that is close to that of water. Preferably the liquid acidic hard surface cleaning compositions herein have a viscosity of up to 50 cps at 60 rpm, more preferably from 0 cps to 30 cps, yet more preferably from 0 cps to 20 cps and most preferably from 0 cps to 10 cps at 60 rpm¹ and 20° C. when measured with a Brookfield digital viscometer model DV II, with spindle 2.

In another preferred embodiment according to the present invention the compositions herein are thickened compositions. Thus, the liquid acidic hard surface cleaning compositions herein preferably have a viscosity of from 50 cps to 5000 cps at 20 s⁻¹, more preferably from 50 cps to 2000 cps, yet more preferably from 50 cps to 1000 cps and most preferably from 50 cps to 500 cps at 20 s⁻¹ and 20° C. when measured with a Rheometer, model AR 1000 (Supplied by TA Instruments) with a 4 cm conic spindle in stainless steal, 2° angle (linear increment from 0.1 to 100 sec⁻¹ in max. 8 minutes). Preferably, the thickened compositions according to this specific embodiment are shear-thinning compositions. The thickened liquid acidic hard surface cleaning compositions herein preferably comprise a thickener, more preferably a polysaccharide polymer (as described herein below) as thickener, still more preferably a gum-type polysaccharide polymer thickener and most preferably Xanthan gum.

### Acidic pH:

The liquid hard surface cleaning composition has an acidic pH. Hence, the liquid hard surface cleaning composition has a pH of less than 7, preferably from 0.5 to 5, more preferably from 1.5 to 2.9, most preferably from 2.0 to 2.5.

Typically, the acids to be used herein may be any organic or inorganic acid well-known to those skilled in the art, or a mixture thereof. Preferably, the organic acids for use herein have a pK of less than 7. Suitable organic acids for use herein, are those selected from the group consisting of: citric acid, maleic acid, lactic acid, glycolic acid, succinic acid, glutaric acid, adipic acid, acetic acid, oxalic acid, methansulfamic acid, formic acid, and mixtures thereof. Preferred organic acids can be selected from the group consisting of: citric acid, acetic acid, lactic acid, oxalic acid, and mixtures thereof.

For improved surface safety and limescale removal efficacy, the acid can be formic acid, preferably formic acid in combination with an acid selected from the group consisting of: citric acid, acetic acid, lactic acid, oxalic acid, and mixtures thereof. In preferred embodiments, the composition can comprise formic acid at a level of from 0.1% to 5.0%, preferably from 0.5 to 4.0%, more preferably from 1.0% to 3.0%, more preferably from 2.0 to 3.0% by weight of the composition.

The compositions of the present invention may comprise from 0.1 to 30%, preferably from 1% to 20%, more preferably from 1.5% to 15%, most preferably from 2% to 10% by weight of the total composition of citric acid.

The compositions of the present invention may comprise from 0.1 to 30%, preferably from 2% to 20%, more preferably from 3% to 15%, most preferably from 3% to 10% by weight of the total composition of acetic acid. In an alternative embodiment herein, the compositions of the present invention may comprise from 0.1 to 5%, preferably from 0.1% to 3%, more preferably from 0.1% to 2%, most preferably from 0.5% to 2% by weight of the total composition of acetic acid.

The compositions herein can comprise lactic acid. It has been found that the presence of lactic acid additionally provides antimicrobial/disinfecting benefits to the compositions according to the present invention. The compositions according to the present invention may comprise up to 10% by weight of the total composition of lactic acid, preferably from 0.1% to 6%, more preferably from 0.2% to 4%, even more preferably from 0.2% to 3%, and most preferably from 0.5% to 2%.

If used, the inorganic acids preferably have a pK of less than 3. Suitable inorganic acids for use herein, are those selected from the group consisting of sulphuric acid, sulfamic acid, hydrochloric acid, phosphoric acid, nitric acid, and mixtures thereof.

The amount of acid herein may vary depending on the amount of other ingredients, but suitable amounts of acids herein generally comprised from 0.01% to 15%, preferably from 0.5% to 10%, more preferably from 1% to 8%, even more preferably from 1% to 6%, still more preferably 1% to 4%, yet more preferably 1% to 3%, yet still more preferably from 1% to 2.5% or from 1% to 2% by weight of the total composition of the acid.

The compositions herein can comprise an alkaline material. Indeed, an alkaline material may be present to trim the pH and/or maintain the pH of the compositions according to the present invention. Examples of alkaline material are sodium hydroxide, potassium hydroxide and/or lithium hydroxide, and/or the alkali metal oxides such, as sodium and/or potassium oxide or mixtures thereof and/or monoethanolamine and/or triethanolamine. Other suitable bases include ammonia, ammonium carbonate, choline base, etc. Preferably, source of alkalinity is sodium hydroxide or potassium hydroxide, preferably sodium hydroxide.

Typically the amount of alkaline material is of from 0.001% to 20% by weight, preferably from 0.01% to 10% and more preferably from 0.05% to 3% by weight of the composition.

Despite the presence of alkaline material, if any, the compositions herein would remain acidic compositions.

For improved limescale removal, the composition preferably has a reserve acidity of at least 1.6, preferably at least 2.4.

### Glycol Ether Solvent:

The hard surface cleaning composition comprises a glycol ether solvent selected from the glycol ethers of Formula 1 or Formula 2.

R₁O(R₂O)ₙR₃ Formula 1:
wherein
R₁ is a linear or branched C₄, C₅ or C₆ alkyl, a substituted or unsubstituted phenyl, preferably n-butyl. Benzyl is one of the substituted phenyls for use herein.
R₂ is ethyl or isopropyl, preferably isopropyl
R₃ is hydrogen or methyl, preferably hydrogen
n is 1, 2 or 3, preferably 1 or 2

R₄O(R₅O)ₘR₆ Formula 2:
wherein
R₄ is n-propyl or isopropyl, preferably n-propyl
R₅ is isopropyl
R₆ is hydrogen or methyl, preferably hydrogen
m is 1, 2 or 3 preferably 1 or 2

Suitable glycol ether solvents according to Formula 1 include ethyleneglycol n-butyl ether, diethyleneglycol n-butyl ether, triethyleneglycol n-butyl ether, propyleneglycol n-butyl ether, dipropyleneglycol n-butyl ether, tripropyleneglycol n-butyl ether, ethyleneglycol n-pentyl ether, diethyleneglycol n-pentyl ether, triethyleneglycol n-pentyl ether, propyleneglycol n-pentyl ether, dipropyleneglycol n-pentyl ether, tripropyleneglycol n-pentyl ether, ethyleneglycol n-hexyl ether, diethyleneglycol n-hexyl ether, triethyleneglycol n-hexyl ether, propyleneglycol n-hexyl ether, dipropyleneglycol n-hexyl ether, tripropyleneglycol n-hexyl ether, ethyleneglycol phenyl ether, diethyleneglycol phenyl ether, triethyleneglycol phenyl ether, propyleneglycol phenyl ether, dipropyleneglycol phenyl ether, tripropyleneglycol phenyl ether, ethyleneglycol benzyl ether, diethyleneglycol benzyl ether, triethyleneglycol benzyl ether, propyleneglycol benzyl ether, dipropyleneglycol benzyl ether, tripropyleneglycol benzyl ether, ethyleneglycol isobutyl ether, diethyleneglycol isobutyl ether, triethyleneglycol isobutyl ether, propyleneglycol isobutyl ether, dipropyleneglycol isobutyl ether, tripropyleneglycol isobutyl ether, ethyleneglycol isopentyl ether, diethyleneglycol isopentyl ether, triethyleneglycol isopentyl ether, propyleneglycol isopentyl ether, dipropyleneglycol isopentyl ether, tripropyleneglycol isopentyl ether, ethyleneglycol isohexyl ether, diethyleneglycol isohexyl ether, triethyleneglycol isohexyl ether, propyleneglycol isohexyl ether, dipropyleneglycol isohexyl ether, tripropyleneglycol isohexyl ether, ethyleneglycol n-butyl methyl ether, diethyleneglycol n-butyl methyl ether triethyleneglycol n-butyl methyl ether, propyleneglycol n-butyl methyl ether, dipropyleneglycol n-butyl methyl ether, tripropyleneglycol n-butyl methyl ether, ethyleneglycol b-pentyl methyl ether, diethyleneglycol n-pentyl methyl ether, triethyleneglycol n-pentyl methyl ether, propyleneglycol n-pentyl methyl ether, dipropyleneglycol n-pentyl methyl ether, tripropyleneglycol n-pentyl methyl ether, ethyleneglycol n-hexyl methyl ether, diethyleneglycol n-hexyl methyl ether, triethyleneglycol n-hexyl methyl ether, propyleneglycol n-hexyl methyl ether, dipropyleneglycol n-hexyl methyl ether, tripropyleneglycol n-hexyl methyl ether, ethyleneglycol phenyl methyl ether, diethyleneglycol phenyl methyl ether, triethyleneglycol phenyl methyl ether, propyleneglycol phenyl methyl ether, dipropyleneglycol phenyl methyl ether, tripropyleneglycol phenyl methyl ether, ethyleneglycol benzyl methyl ether, diethyleneglycol benzyl methyl ether, triethyleneglycol benzyl methyl ether, propyleneglycol benzyl methyl ether, dipropyleneglycol benzyl methyl ether, tripropyleneglycol benzyl methyl ether, ethyleneglycol isobutyl methyl ether, diethyleneglycol isobutyl methyl ether, triethyleneglycol isobutyl methyl ether, propyleneglycol isobutyl methyl ether, dipropyleneglycol isobutyl methyl ether, tripropyleneglycol isobutyl methyl ether, ethyleneglycol isopentyl methyl ether, diethyleneglycol isopentyl methyl ether, triethyleneglycol isopentyl methyl ether, propyleneglycol isopentyl methyl ether, dipropyleneglycol isopentyl methyl ether, tripropyleneglycol isopentyl methyl ether, ethyleneglycol isohexyl methyl ether, diethyleneglycol isohexyl methyl ether, triethyleneglycol isohexyl methyl ether, propyleneglycol isohexyl methyl ether, dipropyleneglycol isohexyl methyl ether, tripropyleneglycol isohexyl methyl ether, and mixtures thereof.

Preferred glycol ether solvents according to Formula 1 are ethyleneglycol n-butyl ether, diethyleneglycol n-butyl ether, triethyleneglycol n-butyl ether, propyleneglycol n-butyl ether, dipropyleneglycol n-butyl ether, tripropyleneglycol n-butyl ether, and mixtures thereof.

Most preferred glycol ethers according to Formula 1 are propyleneglycol n-butyl ether, dipropyleneglycol n-butyl ether, and mixtures thereof.

Suitable glycol ether solvents according to Formula 2 include propyleneglycol n-propyl ether, dipropyleneglycol n-propyl ether, tripropyleneglycol n-propyl ether, propyleneglycol isopropyl ether, dipropyleneglycol isopropyl ether, tripropyleneglycol isopropyl ether, propyleneglycol n-propyl methyl ether, dipropyleneglycol n-propyl methyl ether, tripropyleneglycol n-propyl methyl ether, propyleneglycol isopropyl methyl ether, dipropyleneglycol isopropyl methyl ether, tripropyleneglycol isopropyl methyl ether, and mixtures thereof.

Preferred glycol ether solvents according to Formula 2 are propyleneglycol n-propyl ether, dipropyleneglycol n-propyl ether, and mixtures thereof.

Most preferred glycol ether solvents are propyleneglycol n-butyl ether, dipropyleneglycol n-butyl ether, and mixtures thereof, especially dipropyleneglycol n-butyl ether.

Suitable glycol ether solvents can be purchased from The Dow Chemical Company, more particularly from the E-series (ethylene glycol based) Glycol Ethers and the P-series (propylene glycol based) Glycol Ethers line-ups. Suitable glycol ether solvents include Butyl Carbitol, Hexyl Carbitol, Butyl Cellosolve, Hexyl Cellosolve, Butoxytriglycol, Dowanol Eph, Dowanol PnP, Dowanol DPnP, Dowanol PnB, Dowanol DPnB, Dowanol TPnB, Dowanol PPh, and mixtures thereof.

The glycol ether solvent is typically present at a level of less than 10%, more preferably from 1% to 7% by weight of the composition.

The composition can comprise a further solvent, such as solvents selected from the group consisting of C2-C4 alcohols, C2-C4 polyols, poly alkylene glycol and mixtures thereof.

### Surfactant:

The compositions of the present invention comprises up to 15% by weight of surfactant. Suitable surfactants can be selected from the group consisting of: nonionic surfactants, anionic surfactants, cationic surfactants, amphoteric surfactants, zwitterionic surfactants, and mixtures thereof. More preferred surfactants can be selected from the group consisting of: anionic surfactants, nonionic surfactants, and mixtures thereof. Cationic surfactants are particularly preferred when antimicrobial benefits are desired.

The surfactant and the glycol ether solvent are preferably present in a weight ratio of from 5:1 to 1:1.

In preferred embodiments, the composition comprises one or more nonionic surfactant. It has been found in particular that nonionic surfactants strongly contribute in achieving highly improved performance on greasy soap scum removal.

The compositions comprises up to 15% by weight of the total composition of a nonionic surfactant or a mixture thereof, preferably from 0.1% to 15%, more preferably from 1% to 10%, even more preferably from 1% to 5%, and most preferably from 1% to 3%.

Suitable nonionic surfactants for use herein are alkoxylated alcohol nonionic surfactants, which can be readily made by condensation processes which are well-known in the art, such as the OXO or Ziegler processes.

Suitable alkoxylated alcohols are nonionic surfactants according to the formula RO(E)e(P)pH where R is a hydrocarbon chain of from 2 to 24, preferably 6 to 22 carbon atoms, more preferably C8 to C14, E is ethylene oxide and P is propylene oxide, and e and p which represent the average degree of, respectively ethoxylation and propoxylation, are of from 0 to 24 (with the sum of e+p being at least 1), preferably from 1 to 15, more preferably from 5 to 12. In preferred embodiments, p is 0. Such suitable nonionic surfactants are commercially available from Shell, for instance, under the trade name Neodol® or from BASF under the trade name Lutensol®, Marilpal® from Sasol, or Greenbentine® from Kolbe.

The composition may comprise from 0.1% to 20% by weight of the total composition of an anionic surfactant or a mixture thereof, more preferably from 1% to 10%, even more preferably from 1% to 7%, and most preferably from 1% to 5%.

Anionic surfactants may be included herein as they contribute to the cleaning benefits of the hard-surface cleaning compositions of the present invention. Indeed, the presence of an anionic surfactant contributes to the greasy soap scum cleaning of the compositions herein. More generally, the presence of an anionic surfactant in the liquid acidic compositions according to the present invention allows to lower the surface tension and to improve the wettability of the surfaces being treated with the liquid acidic compositions of the present invention. Furthermore, the anionic surfactant, or a mixture thereof, helps to solubilize the soils in the compositions of the present invention.

Suitable anionic surfactants for use herein are all those commonly known by those skilled in the art. Preferably, the anionic surfactants for use herein include alkyl sulphonates, alkyl aryl sulphonates, or mixtures thereof.

Particularly suitable linear alkyl sulphonates include C8 sulphonate like Witconate® NAS 8 commercially available from Witco.

Other anionic surfactants useful herein include salts (including, for example, sodium, potassium, ammonium, and substituted ammonium salts such as mono-, di- and triethanolamine salts) of soap, alkyl sulphates, alkyl aryl sulphates alkyl alkoxylated sulphates, C8-C24 olefinsulfonates, sulphonated polycarboxylic acids prepared by sulphonation of the pyrolyzed product of alkaline earth metal citrates, e.g., as described in British patent specification No. 1,082,179; alkyl ester sulfonates such as C14-16 methyl ester sulfonates; acyl glycerol sulfonates, alkyl phosphates, isethionates such as the acyl isethionates, N-acyl taurates, alkyl succinamates, acyl sarcosinates, sulfates of alkylpolysaccharides such as the sulfates of alkylpolyglucoside (the nonionic nonsulfated compounds being described below), alkyl polyethoxy carboxylates such as those of the formula RO(CH2CH2O)kCH2COO-M+ wherein R is a C8-C22 alkyl, k is an integer from 0 to 10, and M is a soluble salt-forming cation. Resin acids and hydrogenated resin acids are also suitable, such as rosin, hydrogenated rosin, and resin acids and hydrogenated resin acids present in or derived from tall oil. Further examples are given in “Surface Active Agents and Detergents” (Vol. I and II by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23.

Suitable zwitterionic surfactants for use herein contain both basic and acidic groups which form an inner salt giving both cationic and anionic hydrophilic groups on the same molecule over a relatively wide range of pH's. The typical cationic group is a quaternary ammonium group, although other positively charged groups like phosphonium, imidazolium and sulfonium groups can be used. The typical anionic hydrophilic groups are carboxylates and sulfonates, although other groups like sulfates, phosphonates, and the like can be used.

Some common examples of zwitterionic surfactants (i.e. betaine/sulphobetaine) are described in U.S. Pat. Nos. 2,082,275, 2,702,279 and 2,255,082. For example Coconut dimethyl betaine is commercially available from Seppic under the trade name of Amonyl 265®. Lauryl betaine is commercially available from Albright & Wilson under the trade name Empigen BB/L®. A further example of betaine is Lauryl-immino-dipropionate commercially available from Rhodia under the trade name Mirataine H2C-HA®.

Particularly preferred zwitterionic surfactants for use in the compositions of the present invention are the sulfobetaine surfactants as they deliver optimum soap scum cleaning benefits.

Examples of particularly suitable sulfobetaine surfactants include tallow bis(hydroxyethyl) sulphobetaine, cocoamido propyl hydroxy sulphobetaines which are commercially available from Rhodia and Witco, under the trade name of Mirataine CBS® and Rewoteric AM CAS 15® respectively.

Amphoteric and ampholytic detergents which can be either cationic or anionic depending upon the pH of the system are represented by detergents such as dodecylbeta-alanine, N-alkyltaurines such as the one prepared by reacting dodecylamine with sodium isethionate according to the teaching of U.S. Pat. No. 2,658,072, N-higher alkylaspartic acids such as those produced according to the teaching of U.S. Pat. No. 2,438,091, and the products sold under the trade name “Miranol”, and described in U.S. Pat. No. 2,528,378. Additional synthetic detergents and listings of their commercial sources can be found in McCutcheon's Detergents and Emulsifiers, North American Ed. 1980.

Suitable amphoteric surfactants include the amine oxides. Examples of amine oxides for use herein are for instance coconut dimethyl amine oxides, C12-C16 dimethyl amine oxides. Said amine oxides may be commercially available from Clariant, Stepan, and AKZO (under the trade name Aromox®). Other suitable amphoteric surfactants for the purpose of the invention are the phosphine or sulfoxide surfactants.

Cationic surfactants suitable for use in compositions of the present invention are those having a long-chain hydrocarbyl group. Examples of such cationic surfactants include the quaternary ammonium surfactants such as alkyldimethylammonium halogenides. Other cationic surfactants useful herein are also described in U.S. Pat. No. 4,228,044, Cambre, issued Oct. 14, 1980. Especially preferred are cationic surfactants which provide anti-bacterial benefits, such as quaternary ammonium halides comprising a first dialkyl wherein each alkyl, independently, has from 1 to about 7 carbon atoms, and a second dialkyl wherein each said alkyl, independently, has from about 8 to about 25 carbon atoms; or an N-alkyl dimethyl benzyl ammonium chloride wherein said alkyl has from about 12 to about 18 carbon atoms; or an N-alkyl dimethyl ethyl benzyl ammonium chloride wherein said alkyl has from 12 to about 18 carbon atoms, or any combination thereof.

### Optional Ingredients:

The compositions according to the present invention may comprise a variety of optional ingredients depending on the technical benefit aimed for and the surface treated.

Suitable optional ingredients for use herein include other acids, co-solvents, surfactants, polymers, radical scavengers, chelating agents, perfumes, other surfactants, builders, buffers, bactericides, hydrotropes, colorants, stabilizers, bleaches, bleach activators, suds controlling agents like fatty acids, enzymes, soil suspenders, brighteners, anti-dusting agents, dispersants, pigments, and dyes.

Co-solvent: The composition can comprise a co-solvent, such as co-solvents selected from the group consisting of C2-C4 alcohols, C2-C4 polyols, poly alkylene glycol and mixtures thereof. Typically, the compositions may comprise from 0.1% to 5% by weight of the total composition of a solvent or mixtures thereof, preferably from 0.5% to 5% by weight of the total composition and more preferably from 1% to 3% by weight of the total composition.

Chelating agent: The composition may comprise a chelating agent or mixtures thereof, as a preferred optional ingredient. Chelating agents can be incorporated in the compositions herein in amounts ranging from 0% to 10% by weight of the total composition, preferably 0.01% to 5.0%, more preferably 0.05% to 1%.

Suitable phosphonate chelating agents to be used herein may include alkali metal ethane 1-hydroxy diphosphonates (HEDP), alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities.

Preferred chelating agents to be used herein are diethylene triamine penta methylene phosphonate (DTPMP) and ethane 1-hydroxy diphosphonate (HEDP). In a particularly preferred execution of the present invention, the chelating agent is selected to be ethane 1-hydroxy diphosphonate (HEDP). Such phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins. Ethylenediamine N,N′-disuccinic acids is, for instance, commercially available under the tradename ssEDDS® from Palmer Research Laboratories.

Suitable amino carboxylates to be used herein include ethylene diamine tetra acetates, diethylene tri amine pentaacetates, diethylene triamine pentaacetate (DTPA), N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-acetic acid (MGDA).

Further carboxylate chelating agents to be used herein include salicylic acid, aspartic acid, glutamic acid, glycine, malonic acid or mixtures thereof.

It has been surprisingly found that the addition of a chelating agent, preferably HEDP, in the composition of the present invention provides an unexpected improvement in terms of limescale removal.

Polymers: The composition can comprise one or more polymers. Suitable polymers can be selected from the group consisting of: vinylpyrrolidone homopolymer or copolymers, polysaccharide polymers, surface-modifying polymers other than vinylpyrrolidone homo- or copolymers, structuring and/or thickening polymers, and mixtures thereof.

Vinylpyrrolidone homopolymer or copolymer: The compositions may comprise a vinylpyrrolidone homopolymer or copolymer, or a mixture thereof. Typically, the compositions of the present invention may comprise from 0.01% to 5% by weight of the total composition of a vinylpyrrolidone homopolymer or copolymer, or a mixture thereof, more preferably from 0.05% to 3% and most preferably from 0.05% to 1%.

Suitable vinylpyrrolidone homopolymers for use herein are homopolymers of N-vinylpyrrolidone having the following repeating monomer:

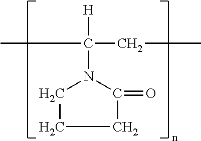

wherein n (degree of polymerisation) is an integer of from 10 to 1,000,000, preferably from 20 to 100,000, and more preferably from 20 to 10,000.

Accordingly, suitable vinylpyrrolidone homopolymers (“PVP”) for use herein have an average molecular weight of from 1,000 to 100,000,000, preferably from 2,000 to 10,000,000, more preferably from 5,000 to 1,000,000, and most preferably from 50,000 to 500,000.

Suitable vinylpyrrolidone homopolymers are commercially available from ISP Corporation, New York, N.Y. and Montreal, Canada under the product names PVP K-15® (viscosity molecular weight of 10,000), PVP K-30® (average molecular weight of 40,000), PVP K-60® (average molecular weight of 160,000), and PVP K-90® (average molecular weight of 360,000). Other suitable vinylpyrrolidone homopolymers which are commercially available from BASF Cooperation include Sokalan HP 165 ®, Sokalan HP 12®, Luviskol K30®, Luviskol K60®, Luviskol K80®, Luviskol K90®; vinylpyrrolidone homopolymers known to persons skilled in the detergent field (see for example EP-A-262,897 and EP-A-256,696).

Suitable copolymers of vinylpyrrolidone for use herein include copolymers of N-vinylpyrrolidone and alkylenically unsaturated monomers or mixtures thereof.

The alkylenically unsaturated monomers of the copolymers herein include unsaturated dicarboxylic acids such as maleic acid, chloromaleic acid, fumaric acid, itaconic acid, citraconic acid, phenylmaleic acid, aconitic acid, acrylic acid, N-vinylimidazole and vinyl acetate. Any of the anhydrides of the unsaturated acids may be employed, for example acrylate, methacrylate. Aromatic monomers like styrene, sulphonated styrene, alpha-methyl styrene, vinyl toluene, t-butyl styrene and similar well known monomers may be used.

For example particularly suitable N-vinylimidazole N-vinylpyrrolidone polymers for use herein have an average molecular weight range from 5,000 to 1,000,000, preferably from 5,000 to 500,000, and more preferably from 10,000 to 200,000. The average molecular weight range was determined by light scattering as described in Barth H. G. and Mays J. W. Chemical Analysis Vol 113, “Modern Methods of Polymer Characterization”.

Such copolymers of N-vinylpyrrolidone and alkylenically unsaturated monomers like PVP/vinyl acetate copolymers are commercially available under the trade name Luviskol® series from BASF.

According to a very preferred execution of the present invention, vinylpyrrolidone homopolymers are advantageously selected.

Suitable structuring and/or thickening polymers include polysaccharide polymers. As such, the compositions of the present invention may optionally comprise a polysaccharide polymer or a mixture thereof. Typically, the compositions of the present invention may comprise from 0.01% to 5% by weight of the total composition of a polysaccharide polymer or a mixture thereof, more preferably from 0.05% to 3% and most preferably from 0.05% to 1%.

Suitable polysaccharide polymers for use herein include substituted cellulose materials like carboxymethylcellulose, ethyl cellulose, hydroxyethyl cellulose, hydroxypropyl cellulose, hydroxymethyl cellulose, succinoglycan and naturally occurring polysaccharide polymers like Xanthan gum, gellan gum, guar gum, locust bean gum, tragacanth gum or derivatives thereof, or mixtures thereof.

In a preferred embodiment according to the present invention the compositions of the present invention comprise a polysaccharide polymer selected from the group consisting of: carboxymethylcellulose, ethyl cellulose, hydroxyethyl cellulose, hydroxypropyl cellulose, hydroxymethyl cellulose, succinoglycan gum, Xanthan gum, gellan gum, guar gum, locust bean gum, tragacanth gum, derivatives of the aforementioned, and mixtures thereof. Preferably, the compositions herein comprise a polysaccharide polymer selected from the group consisting of: succinoglycan gum, Xanthan gum, gellan gum, guar gum, locust bean gum, tragacanth gum, derivatives of the aforementioned, and mixtures thereof. More preferably, the compositions herein comprise a polysaccharide polymer selected from the group consisting of: Xanthan gum, gellan gum, guar gum, derivatives of the aforementioned, and mixtures thereof. Most preferably, the compositions herein comprise Xanthan gum, derivatives thereof, or mixtures thereof.

Particularly polysaccharide polymers for use herein are Xanthan gum and derivatives thereof. Xanthan gum and derivatives thereof may be commercially available for instance from CP Kelco under the trade name Keltrol RD®, Kelzan S® or Kelzan T®. Other suitable Xanthan gums are commercially available by Rhodia under the trade name Rhodopol T® and Rhodigel X747®. Succinoglycan gum for use herein is commercially available by Rhodia under the trade name Rheozan®.

It has surprisingly been found that the polysaccharide polymers or mixtures thereof herein act as surface modifying polymers (preferably combined with a vinylpyrrolidone homopolymer or copolymer, as described herein) and/or as thickening agents. Indeed, the polysaccharide polymers or mixtures thereof herein can be used to thicken the compositions according to the present invention. It has been surprisingly found that the use of polysaccharide polymers or mixtures thereof herein, and preferably Xanthan gum, provides excellent thickening performance to the compositions herein. Moreover, it has been found that the use of polysaccharide polymers or mixtures thereof herein, and preferably Xanthan gum, provides excellent thickening whilst not or only marginally reducing the limescale removal performance. Indeed, thickened compositions usually tend to show a drop in soil/stain removal performance (which in turn requires an increased level of actives to compensate for the performance drop) due to the thickening. It has been found that this is due to the fact that the actives providing the soil/stain removal performance are less free to migrate to the soil/stain. However, it has been surprisingly found that when polysaccharide polymers or mixtures thereof herein, and preferably Xanthan gum, are used as thickeners for the compositions herein, the drop in soil/stain removal performance is substantially reduced or even prevented.

Furthermore, without intended to be bound by theory, it has been shown that vinylpyrrolidone homopolymers or copolymers, preferably the vinylpyrrolidone homopolymer, and polysaccharide polymers, preferably Xanthan gum or derivatives thereof, described herein, when added into an aqueous acidic composition deliver improved shine to the treated surface as well as improved next-time cleaning benefit on said surface, while delivering good first-time hard-surface cleaning performance and good limescale removal performance. Furthermore, the formation of watermarks and/or limescale deposits upon drying is reduced or even eliminated.

Moreover, the vinylpyrrolidone homopolymers or copolymers and polysaccharide polymers further provide long lasting protection against formation of watermarks and/or deposition of limescale deposits, hence, long lasting shiny surfaces.

An additional advantage related to the use of the vinylpyrrolidone homopolymers or copolymers and polysaccharide polymers, in the acidic compositions herein, is that as they adhere on hard surface making them more hydrophilic, the surfaces themselves become smoother (this can be perceived by touching said surfaces) and this contributes to convey perception of surface perfectly descaled.

Advantageously, these benefits are obtained at low levels of vinylpyrrolidone homopolymers or copolymers and polysaccharide polymers, preferably Xanthan gum or derivatives thereof, described herein, thus it is yet another advantage of the present invention to provide the desired benefits at low cost.

Radical scavenger: The compositions of the present invention may further comprise a radical scavenger or a mixture thereof.

Suitable radical scavengers for use herein include the well-known substituted mono and dihydroxy benzenes and their analogs, alkyl and aryl carboxylates and mixtures thereof. Preferred such radical scavengers for use herein include di-tert-butyl hydroxy toluene (BHT), hydroquinone, di-tert-butyl hydroquinone, mono-tert-butyl hydroquinone, tert-butyl-hydroxy anysole, benzoic acid, toluic acid, catechol, t-butyl catechol, benzylamine, 1,1,3-tris(2-methyl-4-hydroxy-5-t-butylphenyl) butane, n-propyl-gallate or mixtures thereof and highly preferred is di-tert-butyl hydroxy toluene. Such radical scavengers like N-propyl-gallate may be commercially available from Nipa Laboratories under the trade name Nipanox S1®.

Radical scavengers, when used, may be typically present herein in amounts up to 10% by weight of the total composition and preferably from 0.001% to 0.5% by weight. The presence of radical scavengers may contribute to the chemical stability of the compositions of the present invention.

Perfume: The composition may comprise a perfume ingredient, or mixtures thereof, in amounts up to 5.0% by weight of the total composition, preferably in amounts of 0.1% to 1.5%.

Colorant: The liquid compositions may be coloured, preferably using one or more acid-stable dye or pigment.

### The Method of Cleaning a Hard-Surface:

The present invention further encompasses a method of cleaning a hard surface, preferably removing limescale and hydrophobic stains from said hard-surface or said object. The method of the present invention is particularly suited for removing hydrophobic stains selected from oils, fats, polymerized grease, and mixtures thereof, especially oils, fats, and mixtures thereof.

Oils are nonpolar substances which are liquid at ambient temperatures (21° C.), and are both hydrophobic (immiscible with water) and lipophilic (miscible with other oils and organic solvents). Oils typically have a high carbon and hydrogen content. Oil includes classes of chemical compounds that may be otherwise unrelated in structure, properties, and uses. Oils may be derived from animal, vegetable, or petrochemicals sources. They are typically used for food, fuel, lubrication, and the manufacture of paints, plastics, and other materials.

Fats are soft greasy solids at ambient temperatures (21° C.), and are also both hydrophobic (immiscible with water) and lipophilic (miscible with other oils and organic solvents). Fats may be animal, vegetable, or petrochemical in origin. They are also typically used for food, fuel, lubrication, and the manufacture of paints, plastics, and other materials.

Polymerised grease are cooked-, baked- or burnt-on oils and fats that have been heated to a temperature, of left sufficiently long, that they polymerise and typically also have an increased viscosity.

Liquid compositions comprising the glycol ether solvents are particularly suitable treating oils, fats, and polymerized grease which have been derived from animal, or vegetable.

The method of the present invention comprises the steps of: applying a liquid acidic hard surface cleaning composition comprising the glycol ether solvent onto a hard-surface; leaving said composition on the hard-surface; optionally wiping the hard-surface and/or providing mechanical agitation, and then rinsing the hard-surface.

By “hard-surface”, it is meant herein any kind of surfaces typically found in and around houses like bathrooms, kitchens, basements and garages, e.g., floors, walls, tiles, windows, sinks, showers, shower plastified curtains, wash basins, WCs, dishes, fixtures and fittings and the like made of different materials like ceramic, enamel, painted and un-painted concrete, plaster, bricks, vinyl, no-wax vinyl, linoleum, melamine, Formica®, glass, any plastics, metals, chromed surface and the like. The term surfaces as used herein also include household appliances including, but not limited to, washing machines, automatic dryers, refrigerators, freezers, ovens, microwave ovens, dishwashers and so on. Preferred hard surfaces cleaned with the liquid aqueous acidic hard surface cleaning composition herein are those located in a bathroom, in a toilet or in a kitchen, basements, garages as well as outdoor such as garden furniture, gardening equipments, driveways etc.

“Hard surface” includes the surface of objects that are subjected to limescale formation thereon. Such objects may be water-taps or parts thereof, water-valves, metal objects, objects made of stainless-steel, cutlery and the like.

The preferred process of cleaning a hard-surface (preferably removing limescale and hydrophobic stains from said hard-surface) comprises the step of applying a composition according to the present invention onto said hard-surface, leaving said composition on said hard-surface to act, preferably for an effective amount of time, more preferably for a period of from 2 seconds to 10 minutes, most preferably for a period of from 5 seconds to 5 minutes; optionally wiping said hard-surface or object with an appropriate instrument, e.g. a sponge; and then preferably rinsing said surface with water.

Even though said hard-surface or object may optionally be wiped and/or agitated during the process herein, it has been surprisingly found that the process of the present invention allows good limescale removal performance without any additional mechanical wiping and/or agitation action. The lack of need for additional wiping and/or mechanical; agitation provides an added convenience for the user of the compositions herein.

In another execution of the present invention is provided a process of cleaning an object, preferably removing limescale from an object, comprising the step of immersing said object in a bath comprising a composition according to the present invention, leaving said object in said bath for the composition to act, preferably for an effective amount of time, more preferably for a period comprised between 1 and 10 minutes, most preferably for a period comprised between 2 and 4 minutes; and then preferably rinsing said object with water.

The compositions of the present invention may be contacted to the surface or the object to be treated in its neat form or in its diluted form. Preferably, the composition is applied in its neat form.

By “diluted form”, it is meant herein that said composition is diluted by the user, typically with water. The composition is diluted prior use to a typical dilution level of 10 to 400 times its weight of water, preferably from 10 to 200 and more preferably from 10 to 100. Usual recommended dilution level is a 1.2% dilution of the composition in water.

The compositions according to the present invention are particularly suitable for treating hard-surfaces located in and around the house, such as in bathrooms, toilets, garages, on driveways, basements, gardens, kitchens, etc., and preferably in bathrooms. It is however known that such surfaces (especially bathroom surfaces) may be soiled by the so-called “limescale-containing soils”. By “limescale-containing soils” it is meant herein any soil which contains not only limescale mineral deposits, such as calcium and/or magnesium carbonate, but also soap scum (e.g., calcium stearate) and other grease (e.g. body grease). By “limescale deposits” it is mean herein any pure limescale soil, i.e., any soil or stains composed essentially of mineral deposits, such as calcium and/or magnesium carbonate.

The compositions herein may be packaged in any suitable container, such as bottles, preferably plastic bottles, optionally equipped with an electrical or manual trigger spray-head.

### Methods:

### A) pH Measurement:

The pH is measured on the neat composition, at 25° C., using a Sartarius PT-10P pH meter with gel-filled probe (such as the Toledo probe, part number 52 000 100), calibrated according to the instructions manual.

### B) Reserve Acidity:

The reserve acidity is measured to pH 7.0 via titration of a 1% solution of the composition using g hydrochloric acid, with 100 grams of product at 20° C.

### Examples

### Comparative Data

The following liquid hard surface cleaning compositions were prepared by simple mixing:

| | A | B | C | D | E* |
|---|---|---|---|---|---|
| | wt % | wt % | wt % | wt % | wt % |
| ¹HLAS | 3.0 | 3.0 | 3.0 | 3.0 | 3.0 |
| ²Neodol 91-8 | 6.5 | 6.5 | 6.5 | 6.5 | 6.5 |
| ³Citric acid | 1.0 | 1.0 | 1.0 | 1.0 | 1.0 |
| ⁴Formic acid | 2.0 | 2.0 | 2.0 | 2.0 | 2.0 |
| ⁵Propylene glycol n-propyl ether | 5.00 | — | — | — | — |
| ⁶Dipropylene glycol n-propyl ether | — | 5.00 | — | — | — |
| ⁷Propylene glycol n-butyl ether | — | — | 5.00 | — | — |
| ⁸Dipropylene glycol n-butyl ether | | | | 5.00 | — |
| Minors (including perfume, dyes, and | up to | up to | up to | up to | Up to |
| preservative) and Water | 100% | 100% | 100% | 100% | 100% |
| pH (through NaOH) | 3 | 3 | 3 | 3 | 3 |

*Comparative
¹linear alkylbenzene sulphonic acid, commercially available from Huntsman
²nonionic surfactant commercially available from Shell.
³commercially available from Jungbunzlauer Ladenburg Gmbh
⁴commercially available from BASF
⁵Dowanol PnP, from The Dow Chemical Company
⁶Dowanol DPnP, from The Dow Chemical Company
⁷Dowanol PnB, from The Dow Chemical Company
⁸Dowanol DPnB, from The Dow Chemical Company

The ability of the compositions to penetrate oil was assessed by measuring the breakthrough time, using the following methodology:

35 gram of water solution containing 0.15% by weight of xanthan gum (supplied by Keltrol™ RD from CP-kelco) was poured into a glossy white ceramic dish plate (Supplied by Ikea—Item: S.Pryle #13781 diameter 26.5 cm).

Olive oil (Sold by Unilever under the Bertoli brand, item number L5313R HO756 MI0002) was dyed red through the addition of 0.05% by weight of red dye (Waxoline Red, red dye pigment supplied by Avecia), stirring for 1 hour in order to provide a homogeneous dye distribution. Then 2.5 grams of the dyed olive oil was delicately deposited onto the water surface thus forming a thin disk of oil layer. The oil disk diameter was measured to ensure that the diameter did not exceed a variation amongst the replicates of more than 20% from the average value.

1 drop of the hard surface cleaning composition was delicately deposited on to the oil layer, in the middle of the oil disk from a 5 ml Pasteur pipette (Supplied by VWR—Item: 5 ml #612-1684), from a height of less than 5 mm.

The breakthrough time was measured as the time recorded from the deposition of the solution drop to the opening of the oil disk identified by the appearance of the water layer in the middle of the oil disk. 8 replicates were required per sample to calculate the average breakthrough time.

The average breakthrough time is shown in the table below:

| | A | B | C | D | E* |
|---|---|---|---|---|---|
| Average breakthrough time (s) | 72 | 68 | 49 | 53 | 143 |

*Comparative

As can be seen from the table above, compositions of the present invention, comprising a glycol ether solvent according to formula I (Dowanol PnB, Dowanol DPnB) or formula II (Dowanol PnP, Dowanol DPnP), improve the penetration of the composition through hydrophobic material, such as oil. Since the solvent improves penetration of the liquid composition into the stain, the improved surfactancy improves the dispersion of such hydrophobic stains within the acidic pH formulation.

### Example Formulations:

The following compositions were made comprising the listed ingredients in the listed proportions (weight %). The examples herein are met to exemplify the present invention but are not necessarily used to limit or otherwise define the scope of the present invention.

| Examples: | 1 | 2 | 3 | 4 | 5 | 6 | 7 | 8 | 9 |
|---|---|---|---|---|---|---|---|---|---|
| Acids | | | | | | | | | |
| Formic acid | 4.0 | 2.0 | 1.8 | 1.8 | 2.5 | 2.0 | 2.0 | 2.0 | 4.0 |
| Acetic acid | — | 3.5 | 8.0 | 8.0 | 3.0 | 6.0 | 7.0 | — | — |
| Citric acid | — | — | — | — | — | — | — | 8.0 | 2.0 |
| Lactic acid | — | — | — | 1.0 | 2.0 | — | 1.0 | — | 1.5 |
| Surfactants | | | | | | | | | |
| Neodol 91-8 ® | 0.5 | 2.2 | 2.2 | 2.2 | 1.5 | 0.45 | 2.5 | 1.8 | 2.0 |
| Sulphated Safol | 2.0 | — | — | — | 1.0 | 2.0 | — | — | — |
| 23 ® | | | | | | | | | |
| Polymers: | | | | | | | | | |
| Kelzan T | 0.40 | 0.25 | 0.25 | 0.25 | 0.25 | 0.10 | 0.40 | 0.30 | 0.25 |
| PVP | 0.25 | 0.05 | 0.05 | 0.25 | 0.05 | — | 0.25 | 0.10 | 0.05 |
| Solvent: | | | | | | | | | |
| Dowanol PnP | 5 | — | — | — | 2 | — | 2 | — | 3 |
| Dowanol DPnP | — | 3 | — | — | 2 | — | — | 4 | — |
| Dowanol PnB | — | — | 4 | — | — | 3 | 4 | — | — |
| Dowanol DPnB | — | — | — | 6 | — | 3 | — | 2 | 3 |
| Misc.: | | | | | | | | | |
| BHT | 0.03 | 0.03 | 0.03 | 0.03 | 0.05 | — | 0.03 | — | 0.05 |
| Perfume | 0.05 | 0.50 | 0.20 | 0.50 | 0.05 | 0.50 | 0.25 | 0.20 | 0.25 |
| Dye | 0.01 | 0.005 | 0.005 | 0.01 | 0.01 | 0.01 | 0.01 | — | 0.005 |
| Alkaline Material: | | | | | | | | | |
| KOH - to pH: | 2.3 | — | 2.9 | 2.8 | 2.8 | — | — | — | — |
| NaOH - to pH: | — | 2.2 | — | — | — | 2.5 | 2.3 | 2.0 | 2.2 |

| | |
|---|---|
| Water: | up to 100% |

Formic acid, lactic acid and acetic acid are commercially available from Aldrich.
Neodol 91-8 ® is a C₉-C₁₁ EO8 nonionic surfactant, commercially available from SHELL.
Sulphated Safol 23 ® is a branched C₁₂₋₁₃ sulphate surfactant based on Safol 23 an alcohol commercially available from Sasol, which has been sulphated.
Kelzan T ® is a Xanthan gum supplied by Kelco.
PVP is a vinylpyrrolidone homopolymer, commercially available from ISP Corporation
Dowanol PnP, Dowanol DpnP, Dowanol PnB, Dowanol DPnB, commercially available from The Dow Chemical Company
BHT is Butylated Hydroxy Toluene

Example compositions 1 to 9 exhibit good or excellent limescale removal performance and hydrophobic stain removal, whilst providing good surface safety on the treated surface.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid hard surface cleaning composition comprising:
a) a glycol ether solvent selected from the group consisting of glycol ethers of:
i. Formula I: R₁O(R₂O)ₙR₃;
ii. Formula II: R₄O(R₅O)ₘR₆; and
iii. mixtures thereof;
wherein:
R₁ is a linear or branched C₄, C₅ or C₆ alkyl or a substituted or unsubstituted phenyl, R₂ is ethyl or isopropyl, R₃ is hydrogen or methyl, and n is 1, 2 or 3;
R₄ is n-propyl or isopropyl, R₅ is isopropyl, R₆ is hydrogen or methyl and m is 1, 2 or 3;
b) up to about 15% by weight of surfactant;
wherein the liquid hard surface cleaning composition has an acidic pH.

2. The liquid hard surface cleaning composition according to claim 1, wherein the composition has a pH of from about 0.5 to about 5.

3. The hard surface cleaning composition according to claim 1, wherein the composition comprises an acid selected from the group consisting of: citric acid, maleic acid, lactic acid, glycolic acid, succinic acid, glutaric acid, adipic acid, acetic acid, oxalic acid, methansulfamic acid, formic acid, and mixtures thereof.

4. The hard surface cleaning composition according to claim 1, wherein the acid is formic acid in combination with an acid selected from the group consisting of: citric acid, acetic acid, lactic acid, oxalic acid, and mixtures thereof.

5. The hard surface cleaning composition according to claim 1, wherein the composition comprises a non-ionic surfactant.

6. The hard surface cleaning composition according to claim 1, wherein the non-ionic surfactant is the condensation product of ethylene and/or propylene oxide with an alcohol having a straight alkyl chain comprising from about 6 to about 22 wherein the degree of ethoxylation/propoxylation is from about 1 to about 15 or mixtures thereof.

7. The hard surface cleaning composition according to claim 1, wherein the surfactant and the glycol ether solvent are present in a weight ratio of from 5:1 to 1:1.

8. The hard surface cleaning composition according to claim 1, wherein the glycol ether solvent is selected from the group consisting of:
a) Formula I, wherein R₂ is isopropyl and R₃ is H, and n is 1 or 2, R1 is linear C4 to C6 or phenyl;
b) Formula II, wherein R₆ is H, and m is 1 or 2, wherein R₄ is n-propyl;
c) and mixtures thereof.

9. The hard surface cleaning composition according to claim 1, wherein the composition further comprises a polymer, a vinylpyrrolidone homopolymer or copolymer, a polysaccharide polymer, and mixtures thereof.

10. The hard surface cleaning composition according to claim 1, wherein the composition further comprises an alkaline material, selected from the group consisting of sodium hydroxide, potassium hydroxide, lithium hydroxide, the alkali metal oxides such, as sodium and/or potassium oxide or mixtures thereof, monoethanolamine, triethanolamine, ammonia, ammonium carbonate and, choline base and mixtures thereof.

11. A method of removing a combination of limescale and hydrophobic stain on a hard surface, comprising the steps of:
a) applying onto the hard surface, a liquid acidic hard surface cleaning composition comprising a glycol ether solvent selected from the group consisting of glycol ethers of:
i. Formula I: R₁O(R₂O)ₙR₃;
ii. Formula II: R₄O(R₅O)ₘR₆; and
iii. mixtures thereof;
wherein:
R₁ is a linear or branched C₄, C₅ or C₆ alkyl or a substituted or unsubstituted phenyl, R₂ is ethyl or isopropyl, R₃ is hydrogen or methyl, and n is 1, 2 or 3;
R₄ is n-propyl or isopropyl, R₅ is isopropyl, R₆ is hydrogen or methyl and m is 1, 2 or 3;
b) optionally wiping said hard-surface and/or providing mechanical agitation, and then rinsing the hard-surface.

12. The method according to claim 11, wherein the liquid acidic hard surface cleaning composition is selected from the compositions of claim 1.

13. The method according to claim 11, wherein the hydrophobic stain selected from the group consisting of: oils, fats, polymerized grease, and mixtures thereof, especially oils, fats, and mixtures thereof.

14. The method according to claim 11, wherein the hard surface is located in a kitchen.

15. The method of use of a glycol ether solvent in an acidic cleaning composition, for removing hydrophobic stains from a hard surface,
a) The method of use according to claim 11, wherein the glycol ether solvent is selected from the group consisting of glycol ethers of:
i. Formula I: R₁O(R₂O)ₙR₃;
ii. Formula II: R₄O(R₅O)ₘR₆; and
iii. mixtures thereof;
wherein:
R₁ is a linear or branched C₄, C₅ or C₆ alkyl or a substituted or unsubstituted phenyl, R₂ is ethyl or isopropyl, R₃ is hydrogen or methyl, and n is 1, 2 or 3;
R₄ is n-propyl or isopropyl, R₅ is isopropyl, R₆ is hydrogen or methyl and m is 1, 2 or 3;
